(19) United States
(12) Patent Application Publication
(10) Pub. No.: US 2023/0051618 A1
(43) Pub. Date: Feb. 16, 2023

(54) CONTROL DEVICE, CONTROL METHOD, AND PROGRAM

(71) Applicant: SONY GROUP CORPORATION, TOKYO (JP)

(72) Inventors: YOSHIHITO OHKI, TOKYO (JP); DAISUKE SHIONO, TOKYO (JP); SEIJI SUZUKI, TOKYO (JP); YOHEI NAKAJIMA, TOKYO (JP)

(21) Appl. No.: 17/798,463

(22) PCT Filed: Feb. 3, 2021
(86) PCT No.: PCT/JP2021/003825

§ 371 Date: Aug. 9, 2022

(30) Foreign Application Priority Data
Feb. 17, 2020 (JP) 2020-024574

(51) Int. Cl. B25J 11/00; G05D 1/02; A47F 10/06

(52) U.S. Cl. CPC B25J 11/008; G05D 1/0289; A47F 10/06

(57) ABSTRACT

The present technology relates to a control device, a control method, and a program that make it possible for objects that are capable of moving autonomously to move in corporation with each other. The control device according to one aspect of the present technology moves, in response to an action made by a user on a predetermined object among multiple objects that are capable of moving autonomously, an object corresponding with the predetermined object. The present technology can be applied to a control device that controls mobile robots.

### TECHNICAL FIELD

The present technology particularly relates to a control device, a control method, and a program that make it possible for objects that are capable of moving autonomously to move in corporation with each other.

### BACKGROUND ART

Various technologies relating to livelihood support using a robot have been proposed. For example, PTL 1 discloses a robot that corrects the posture of an item to be used by a user such as an elderly person, to such a posture that the item can be picked up easily by the user.

### CITATION LIST

### Patent Literature

### [PTL 1]

Japanese Patent Laid-Open No. 2013-22705

### SUMMARY

### Technical Problem

If tableware such as dishware autonomously moves and if a person and a piece of tableware interact with each other or pieces of tableware interact with each other, then it is possible to not only help a user to eat during a meal but also serve the meal with an interesting presentation.

The present technology has been made in view of such a situation as just described, and the object thereof is to make it possible for objects that are capable of moving autonomously to move in corporation with each other.

### Solution to Problem

A control device according to one aspect of the present technology includes a control unit that moves, in response to an action made by a user on a predetermined object among multiple objects that are capable of moving autonomously, an object corresponding with the predetermined object.

According to the one aspect of the present technology, in response to an action made by a user on a predetermined object among multiple objects that are capable of moving autonomously, an object corresponding with the predetermined object is moved.

### BRIEF DESCRIPTION OF DRAWINGS

FIG. 1 is a view depicting an example of use of tableware according to an embodiment of the present technology.

FIG. 2 depicts views of examples of tableware.

FIG. 3 is an enlarged view of a mobile robot.

FIG. 4 is a view depicting an example of control of the mobile robot.

FIG. 5 is a view depicting an initial state of tableware.

FIG. 6 is a view depicting an example of the movement of the tableware when a user takes a seat.

FIG. 7 is a view depicting an example of the movement of the tableware at the start of a meal.

FIG. 8 is a view depicting an example of the movement of the tableware based on a correspondence between pieces of the tableware.

FIG. 9 is a view depicting an example of the correspondence between pieces of the tableware.

FIG. 10 is a view depicting another example of the movement of the tableware based on the correspondence.

FIG. 11 is a view depicting an example of the movement of the tableware when the table is cleaned.

FIG. 12 is a view depicting an example of priority levels.

FIG. 13 is a view depicting an example of the movement based on the priority levels.

FIG. 14 is a view depicting another example of the priority levels.

FIG. 15 is a view depicting another example of the movement based on the priority levels.

FIG. 16 is a block diagram depicting an example of a hardware configuration of a host PC.

FIG. 17 is a block diagram depicting an example of a functional configuration of the host PC.

FIG. 18 depicts views of examples of fixed values and variation values.

FIG. 19 is a flow chart for explaining general processing performed by the host PC.

FIG. 20 is a flow chart following FIG. 19.

### DESCRIPTION OF EMBODIMENT

In the following, a mode for carrying out the present technology is described. The description is given in the following order.

1. Configuration of Tableware

2. Example of Interaction

3. Configuration and Operation of Host PC

4. Others

### <Configuration of Tableware>

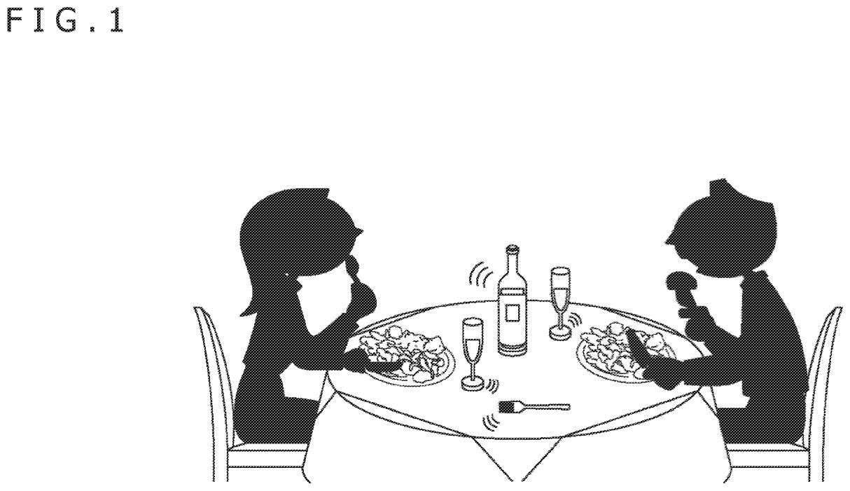

FIG. 1 is a view depicting an example of use of tableware according to an embodiment of the present technology.

The tableware according to the embodiment of the present technology is used on a table where a user has a meal. The tableware includes not only dishware such as plates, cups, and glasses and cutleries such as forks, spoons, and knives but also various items used for dining and arranged side by side on the table, such as packaged seasonings of sugar, salt, or pepper, a wine bottle, or a carafe.

In the example of FIG. 1, a wine bottle, two glasses, and a fork are depicted in the proximity of the center of a circular table. Such pieces of tableware have a function of autonomously moving according to a user action, the progress of the meal, the cooking situation, and so forth, as depicted in FIG. 1.

In order to help a user to eat during a meal or give a presentation in serving the meal, the movement of the tableware is performed through the interaction with the user or the interaction between pieces of the tableware.

For example, in response to an event that a user picks up a certain dish, another dish placed on the table moves toward the user, to thereby help the user to eat during the meal. A sensor such as a camera is mounted in the inside of the table or above the table. By analyzing a result of detection by the sensor, it is recognized that the user takes a seat or leaves the seat, and the user is identified, for example.

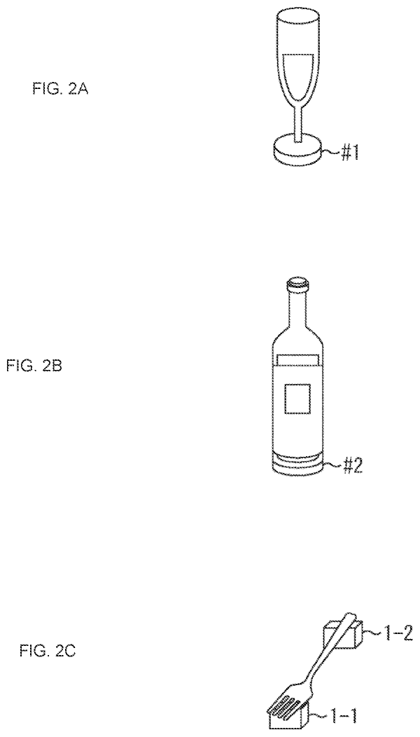

FIG. 2 depicts views of examples of tableware.

As depicted in A of FIG. 2, an accommodation portion #1 is provided on the bottom face of a glass. The accommodation portion #1 of a thin cylindrical shape is a portion in which a mobile robot is accommodated. When the mobile robot accommodated in the accommodation portion #1 moves, the movement of the glass is performed.

As depicted in B of FIG. 2, an accommodation portion #2 in which a mobile robot is accommodated is provided also on the bottom face of a wine bottle. When the mobile robot accommodated in the accommodation portion #2 moves, the movement of the wine bottle is performed.

As depicted in C of FIG. 2, the movement of a fork is performed when two mobile robots, that is, mobile robots 1-1 and 1-2, move cooperatively. In the example of C of FIG. 2, a tip end portion of the fork is placed on the upper face of the mobile robot 1-1, and a terminal end portion of the fork is placed on the upper face of the mobile robot 1-2.

In such a manner, the movement of a piece of tableware is performed by one or more mobile robots. In some cases, the mobile robot may be used by being accommodated on the bottom face side of a piece of tableware or may be used in a state of being exposed to the outside as depicted in C of FIG. 2. The same configuration as the mobile robot may be adopted in the tableware, and the movement of the tableware may be performed by the tableware itself.

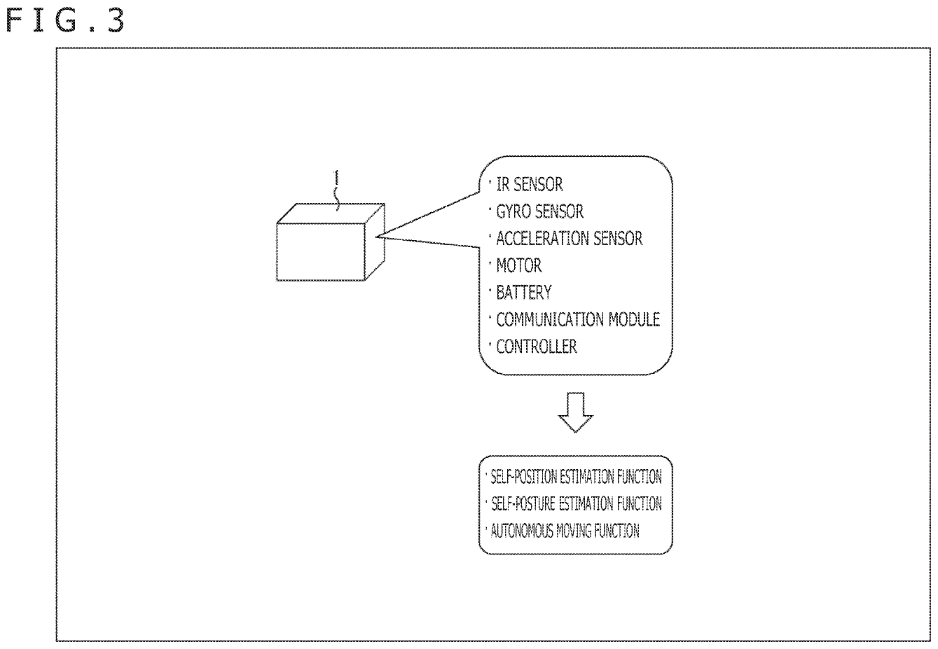

FIG. 3 is an enlarged view of the mobile robot.

As depicted in FIG. 3, a mobile robot 1 has a small-sized housing of a substantially cubic shape. A wheel is provided on the bottom face of the housing.

In the mobile robot 1, various sensors such as an IR sensor, a gyro sensor, and an acceleration sensor, a drive motor for driving the wheel provided on the bottom face, a battery, a communication module for Bluetooth (registered trademark), a wireless LAN, or the like, and a controller for performing control are mounted.

The controller controls the respective components of the mobile robot 1 to implement a self-position estimation function, a self-posture estimation function, and an autonomous moving function as indicated at the end of an outline arrow in FIG. 3.

The self-position estimation function is a function of reading a pattern printed on a mat laid on the table with the use of the IR sensor (optical sensor) provided on the bottom face of the mobile robot 1, and converting the read pattern into an absolute position on the table. At each position on the mat laid on the table, information representing the position is printed.

The self-posture estimation function is implemented with the use of a result of detection by the gyro sensor and the acceleration sensor.

In place of using the sensors mounted in the mobile robot 1, external sensors may be used to implement the self-position estimation function and the self-posture estimation function. For example, it is possible to estimate the position and the posture of the mobile robot 1 by analyzing an image captured by the camera that images the overall top plate of the table, or analyzing a result of detection by a depth sensor.

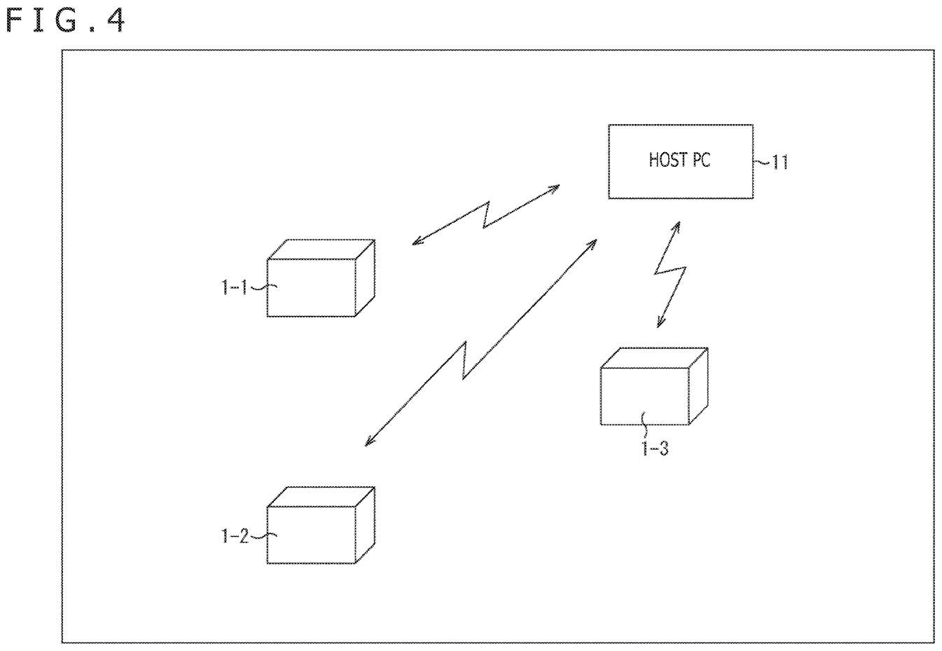

FIG. 4 is a view depicting an example of control of the mobile robot.

As depicted in FIG. 4, the movements of the respective mobile robots 1 including the mobile robots 1-1 to 1-3 is controlled by a host PC 11. The host PC 11 functions as a control device for controlling the movements of the mobile robots 1. The host PC 11 is provided in the proximity of the table, such as on the rear face of the top plate of the table.

For example, information relating to the position and the posture of the mobile robot 1-1 that are estimated by the mobile robot 1-1 is transmitted from the mobile robot 1-1 to the host PC 11 and is then transmitted from the host PC 11 to the mobile robot 1-2 and the mobile robot 1-3. Also, information relating to the positions and the postures of the mobile robots 1-2 and 1-3 is transmitted to the other mobile robots 1 through the host PC 11 in a similar manner.

Accordingly, each of the mobile robots 1 shares the position and the posture thereof with the other mobile robots 1. The position and the posture of the mobile robot 1 may be shared not through the host PC 11 but directly with the other mobile robots 1 by broadcasting.

Various kinds of interaction between pieces of tableware are implemented by the mobile robots 1 and the host PC 11. Also, the movement of each piece of tableware to be described below is implemented when the movements of the mobile robots 1 is controlled by the host PC 11.

### <Example of Interaction>

Initial State

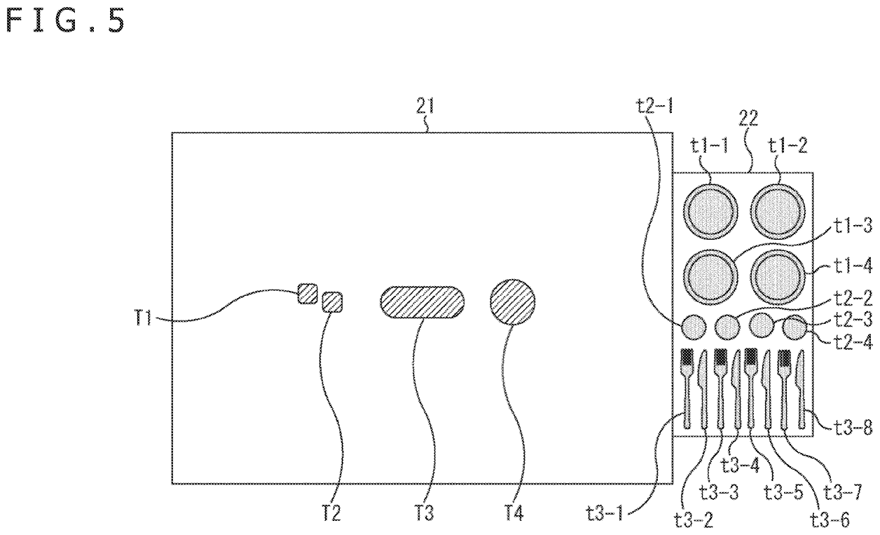

FIG. 5 is a view depicting an initial state of tableware.

FIG. 5 depicts a state of a table 21 of a transversely elongated rectangular shape when viewed from above. A wagon 22 for preparing tableware on the table 21 and putting the tableware away is placed adjacent to the table 21.

In the example of FIG. 5, each piece of tableware is depicted in silhouette. The tableware depicted with slanting lines is shared tableware, and the tableware depicted in light color is individual tableware. This similarly applies to the other figures.

The shared tableware is tableware shared by multiple users who are having a meal around the table 21. The individual tableware is tableware allocated to each user and used by each user.

In the initial state, a seasoning T1, a seasoning T2, a bread container T3, and a wine bottle T4 that are pieces of the shared tableware are placed in the proximity of the center of the table 21. For example, the seasoning T1 is sugar, and the seasoning T2 is pepper.

Meanwhile, on the wagon 22, plates t1-1 to t1-4, glasses t2-1 to t2-4, and cutleries t3-1 to t3-8 that are pieces of the individual tableware for four people are placed. The cutleries t3-1, t3-3, t3-5, and t3-7 are forks, and the cutleries t3-2, t3-4, t3-6, and t3-8 are knives.

Movement when User Takes Seat

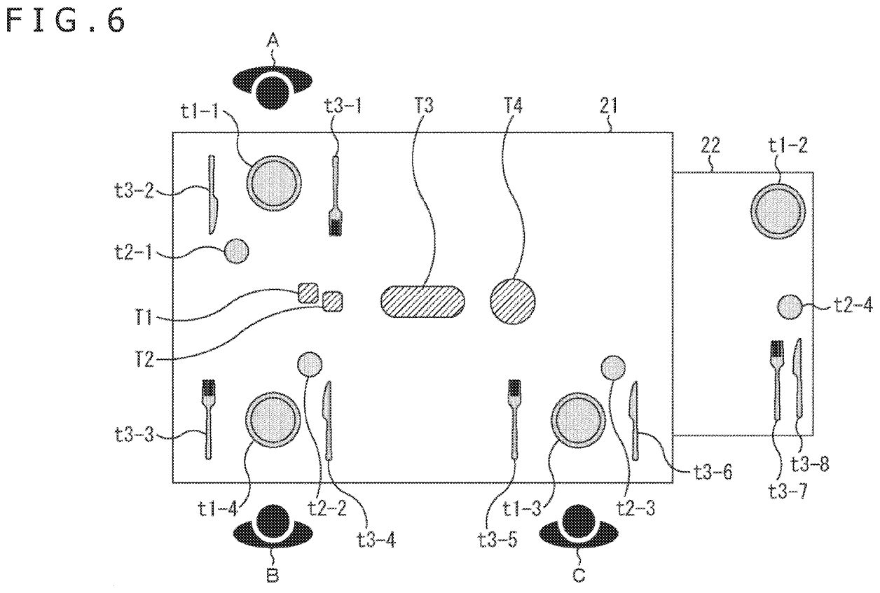

FIG. 6 is a view depicting an example of the movement of the tableware when a user takes a seat.

In a case where users take a seat, the pieces of individual tableware which are placed on the wagon 22 in the initial state start moving and are placed at respective predetermined positions on the basis of the positions of the users, as depicted in FIG. 6.

The host PC 11 recognizes the positions of the users on the basis of a result of detection by the sensors provided, for example, at the respective positions on the table 21, and performs a process for moving the pieces of individual tableware toward the front of the respective users. The positions of the users may be recognized on the basis of an image captured by the camera.

In the example of FIG. 6, in front of a user A who is seated at the left end of the table 21, the plate t1-1 is placed, and the cutleries t3-1 and t3-2 are placed on the left and the right of the plate t1-1, respectively. On the back of the plate t1-1, the glass t2-1 is placed. In this example, one plate, one set of a fork and a knife, and one glass are allocated as pieces of individual tableware to each of the users.

Similarly, in front of a user B and a user C, pieces of individual tableware allocated to the user B and the user C are placed. On the wagon 22, the plate t1-2, the glass t2-4, and the cutleries t3-7 and t3-8 are left.

Pieces of tableware may not always be placed at fixed positions based on the position of a user, and the placement positions of pieces of tableware may be changed according to an attribute of a user who takes a seat. In this case, the host PC 11 identifies the user who takes a seat, by analyzing an image captured by the camera or by other means. Further, an attribute of the user, such as a dominant arm or a preference, is specified. For example, information that indicates attributes of the respective users is managed in advance by the host PC 11.

Otherwise, pieces of individual tableware to be allocated to a user may be changed according to an attribute of the user.

As a result, the host PC 11 can help a user to eat during a meal according to the attribute of the user.

Movement at Start of Meal

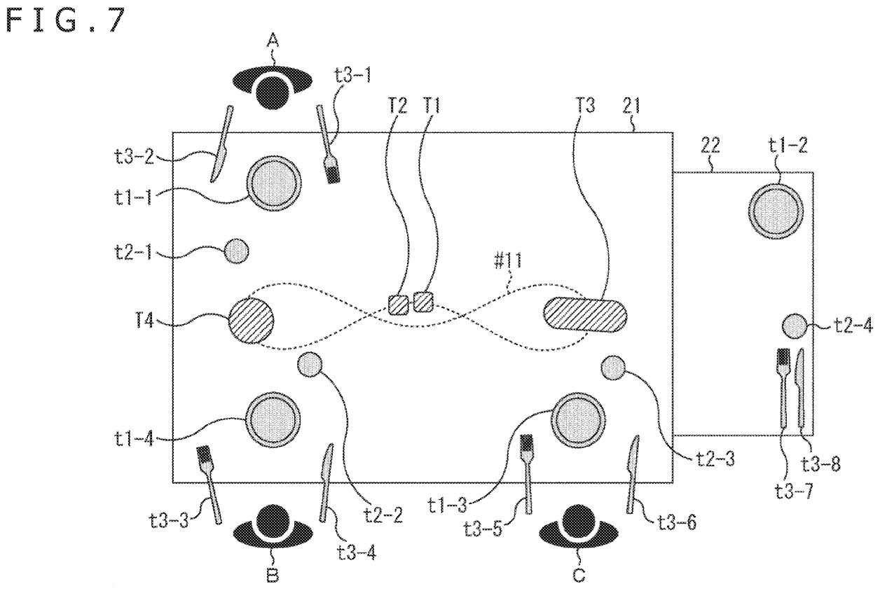

FIG. 7 is a view depicting an example of the movement of the tableware at the start of a meal.

In a case where a user picks up a cutlery, this action becomes a trigger to start the meal, and the pieces of shared tableware arranged side by side in the proximity of the center of the table 21 start moving around on the table 21 as depicted in FIG. 7.

In the example of FIG. 7, the users A, B, and C pick up the respective cutleries placed in front of them. The seasoning T1, the seasoning T2, the bread container T3, and the wine bottle T4 that are the pieces of shared tableware move along a line that passes in front of the respective users in order, as indicated by a broken line #11. Each user can pick up and use any piece of shared tableware moving in front of the user.

Correspondence Between Pieces of Tableware

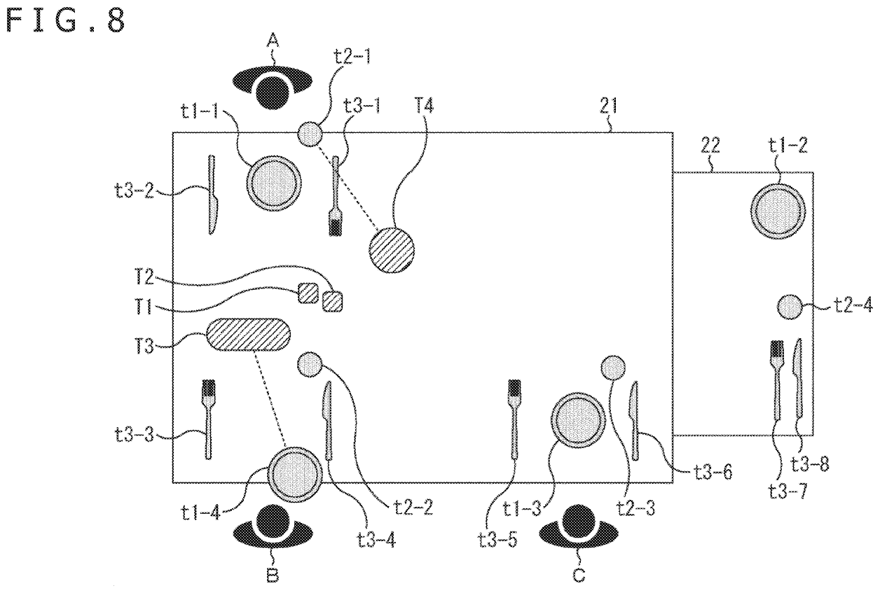

FIG. 8 is a view depicting an example of the movement of the tableware based on a correspondence between pieces of the tableware.

There is a correspondence between some pieces of the individual tableware and some pieces of the shared tableware. In a case where a user picks up a piece of the individual tableware that corresponds with a piece of the shared tableware, control is performed such that the corresponding shared tableware moves toward the user.

For example, in a case where the user A picks up the glass t2-1 as depicted in FIG. 8, the wine bottle T4 that is a piece of the shared tableware corresponding with the glass t2-1 moves toward the user A. In FIG. 8, pieces of tableware corresponding with each other are connected by a broken line.

Meanwhile, in a case where the user B picks up the plate t1-2, the bread container T3 that is a piece of the shared tableware corresponding with the plate t1-2 moves toward the user B.

It is to be noted that the event that a user picks up (lifts) a piece of tableware is detected, for example, on the basis of a change in capacitance of the top plate of the table 21. An image captured by the camera may be analyzed to detect the event that the user picks up a piece of tableware.

Although it has been described that a motion of picking up a piece of tableware becomes a trigger to move the corresponding tableware, some other motion such as a motion of touching, tapping, or pointing at a piece of tableware may be a trigger to start moving the corresponding tableware.

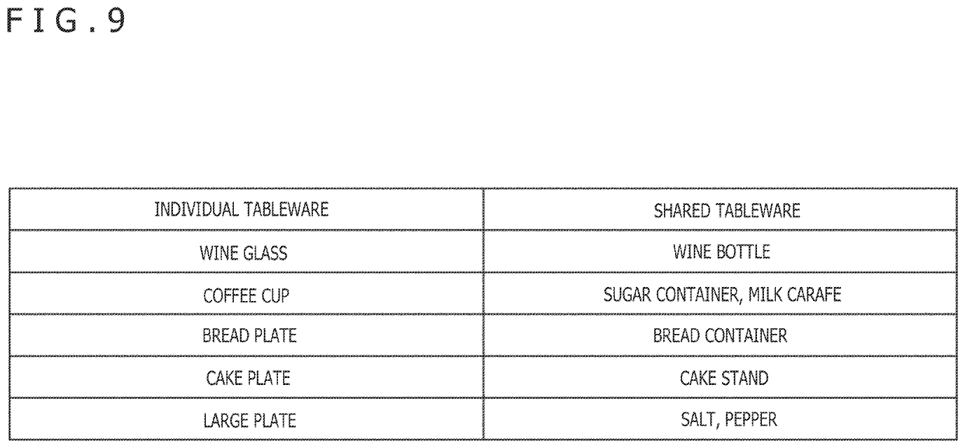

FIG. 9 is a view depicting an example of the correspondence between pieces of the tableware.

As depicted in FIG. 9, for example, a wine glass that is a piece of individual tableware and a wine bottle that is a piece of shared tableware are set as pieces of tableware corresponding with each other. The glasses t2-1 to t2-4 are wine glasses and are pieces of individual tableware corresponding with the wine bottle 14.

Similarly, the correspondence is set such that a coffee cup, a bread plate, a cake plate, and a large plate that are pieces of individual tableware correspond respectively with a sugar container and a milk carafe, a bread container, a cake stand, and salt and pepper that are pieces of shared tableware.

In such a manner, some of the pieces of individual tableware and shared tableware that are supposed to be used in combination are set as pieces of tableware corresponding with each other. In response to an event that a user picks up a certain piece of individual tableware, a piece of shared tableware corresponding with the certain piece of individual tableware is moved toward the user. Thus, it is possible to help the user to take a next action smoothly.

For example, in a case where a user picks up a wine glass, it is predicted, as a next action, that the user will pour the wine into the wine glass and drink the wine. Therefore, moving the wine bottle toward the user supports the next action of the user. Further, in a case where a user picks up a coffee cup filled with coffee, it is predicted, as a next action, that the user will put sugar into the coffee. Therefore, moving the sugar container and the milk carafe toward the user supports the next action of the user.

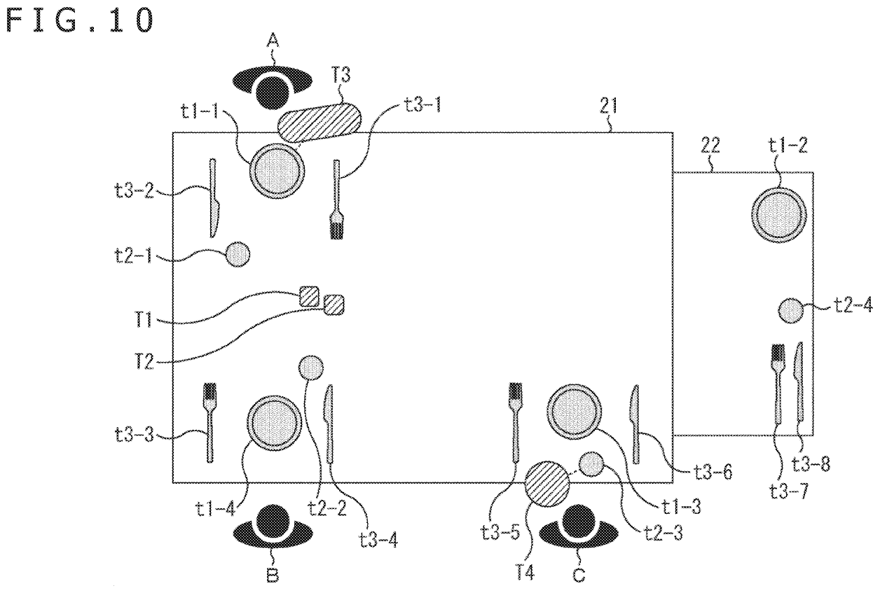

FIG. 10 is a view depicting another example of the movement of the tableware based on the correspondence.

In a case where a user picks up a piece of shared tableware that corresponds with a piece of individual tableware, control is similarly performed such that the corresponding individual tableware moves toward the user.

For example, in a case where the user A picks up the bread container T3 as depicted in FIG. 10, the plate t1-1 that is a piece of individual tableware corresponding with the bread container T3 moves toward the user A.

Further, in a case where the user C picks up the wine bottle T4, the glass t2-3 that is a piece of individual tableware corresponding with the wine bottle T4 moves toward the user C.

In response to an event that a user picks up a certain piece of shared tableware, a piece of individual tableware corresponding with the certain piece of shared tableware is moved toward the user. Thus, it is possible to help the user to take a next action smoothly.

Movement when Table is Cleaned

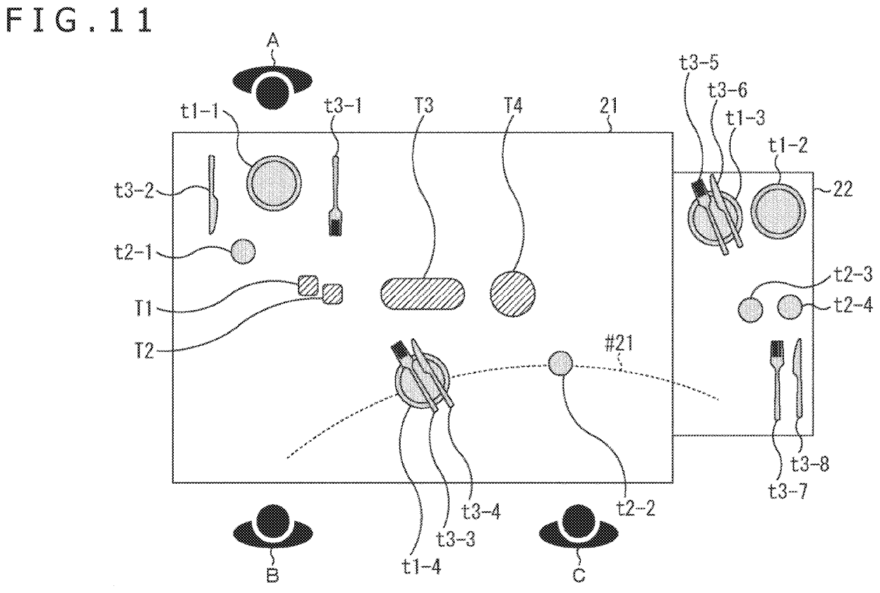

FIG. 11 is a view depicting an example of the movement of the tableware when the table is cleaned.

In a case where a user places cutleries that have been used by the user, on a plate in such a manner that the cutleries are diagonally arranged side by side, this action becomes a trigger to end the meal. The pieces of individual tableware used by the user who finishes eating move to the wagon 22 to clean the table. The cutleries that are placed on the plate in a state of being diagonally arranged side by side are detected, for example, by analysis of an image captured by the camera.

In the example of FIG. 11, in response to an event that the cutlery t3-3 and the cutlery t3-4 are placed on the plate t1-4 by the user B in a state of being diagonally arranged side by side, the glass t2-2 that is a piece of individual tableware used by the user B is moved to the wagon 22 as indicated by a broken line #21. Further, following the glass t2-2, the plate t1-4 on which the cutlery t3-3 and the cutlery t3-4 are placed is moved to the wagon 22.

Also, pieces of the individual tableware used by the user C have been moved to the wagon 22 in a similar manner, and the table has been cleaned. It is to be noted that, even in a case where the pieces of individual tableware have been moved to the wagon 22, the pieces of shared tableware remain on the table 21 in a state of being placed side by side.

In such a manner, the table is cleaned automatically in response to the end of the meal. The user need not put the individual tableware away by him- or herself.

By moving the tableware in such a manner as described above, it is possible to help a user to eat during a meal and give a presentation in serving the meal.

Such a movement of tableware as described above is performed similarly not only in a case of dining such as a general dinner where people eat while being seated, but also in a case of dining such as a stand-up meal where people eat while standing. For example, in a case where a user approaches the table 21 in a state of standing, this action is detected, and pieces of individual tableware are placed on the basis of the position of the user.

Moving Process

The movement of a piece of tableware is performed basically by using, as a movement path, a straight line interconnecting a start position to a goal position of the movement. With this, the movement is performed along the shortest path.

In a case where another piece of tableware is present on the shortest path, setting of the path is performed according to a priority level set to each piece of tableware. The host PC 11 manages the priority levels of the pieces of tableware.

In a case where, on a movement path of a tableware piece P to be moved, another tableware piece Q is present, the tableware piece whose priority level is relatively low moves to avoid the tableware piece having a higher priority level.

For example, in a case where the priority level of the tableware piece P is higher than the priority level of the tableware piece Q, the tableware piece Q moves to avoid the movement path of the tableware piece P. In this case, the tableware piece P can move to the goal position by using the shortest path.

On the other hand, in a case where the priority level of the tableware piece P is lower than the priority level of the tableware piece Q, the movement path of the tableware piece P is reset to avoid the position of the tableware piece Q. In this case, the tableware piece P moves by using a path different from the shortest path.

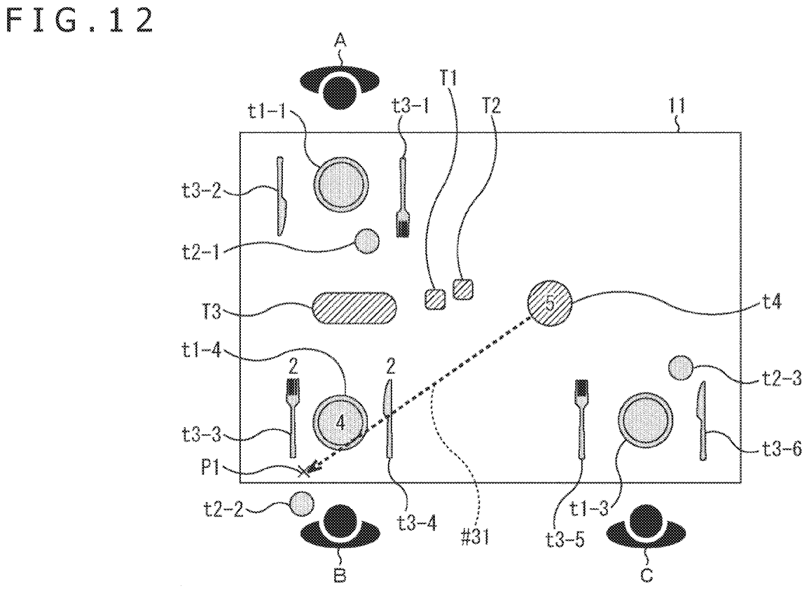

FIG. 12 is a view depicting an example of the priority levels.

There is now described a case where the wine bottle T4 that is a piece of shared tableware is a target of the movement and is to be moved to a position P1 close to the user B in response to an event that the user B picks up the glass t2-2, for example.

The shortest path is a linear path indicated by a broken line #31. On the shortest path, the cutlery t3-4 and the plate t1-4 are present. Further, if the wine bottle T4 moves to the position P1, the wine bottle T4 will collide with part of a handle of the cutlery t3-4. Therefore, the cutlery t3-3 is handled similarly to any piece of tableware present on the shortest path.

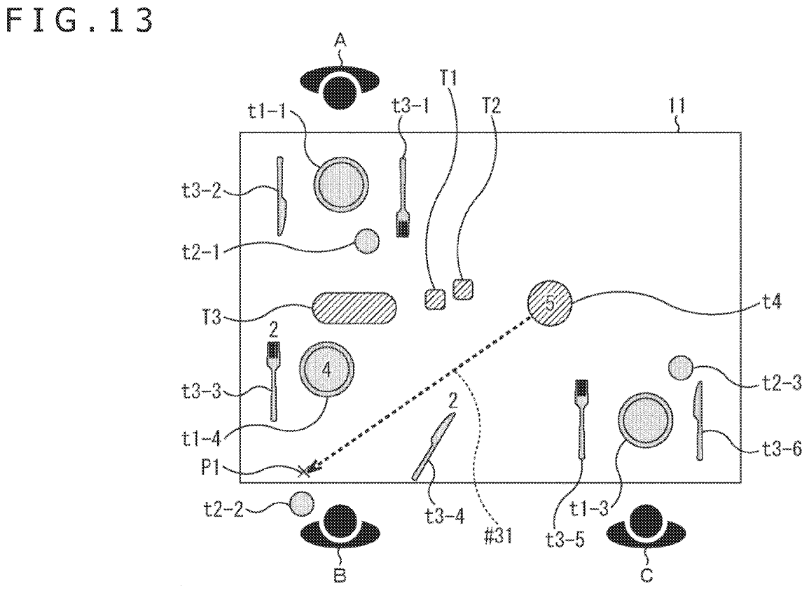

Referring to FIG. 13, a numeral indicated on a piece of tableware or in the proximity of a piece of tableware represents a priority level set to the piece of tableware. In the example of FIG. 12, the priority level of the wine bottle T4 is “5.” The priority levels of the cutleries t3-3 and t3-4 are “2,” and the priority level of the plate t1-4 is “4.” Similarly, priority levels are set to the other pieces of tableware.

In this case, the priority level of the wine bottle T4 that is the target of the movement is higher than the priority levels of the cutleries t3-3 and t3-4 and the plate t1-4. Therefore, the cutleries t3-3 and t3-4 and the plate t1-4 each move to avoid the movement path of the wine bottle T4, as depicted in FIG. 13. The wine bottle T4 can then move to the position P1 that is the goal position, by using the shortest path indicated by the broken line #31.

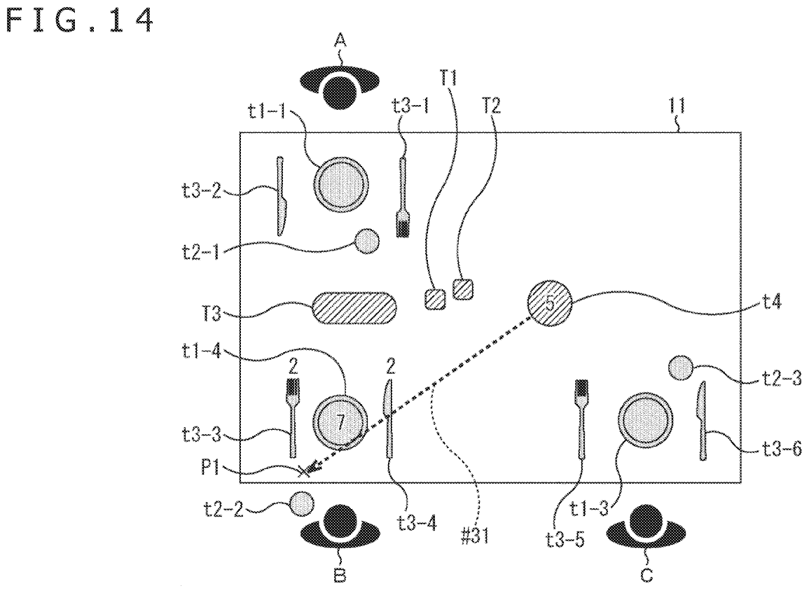

FIG. 14 is a view depicting another example of the priority levels.

In the example of FIG. 14, the priority level of the plate t1-4 is “7.” The priority levels of the wine bottle T4 and the cutleries t3-3 and t3-4 are the same as the priority levels described hereinabove with reference to FIG. 12.

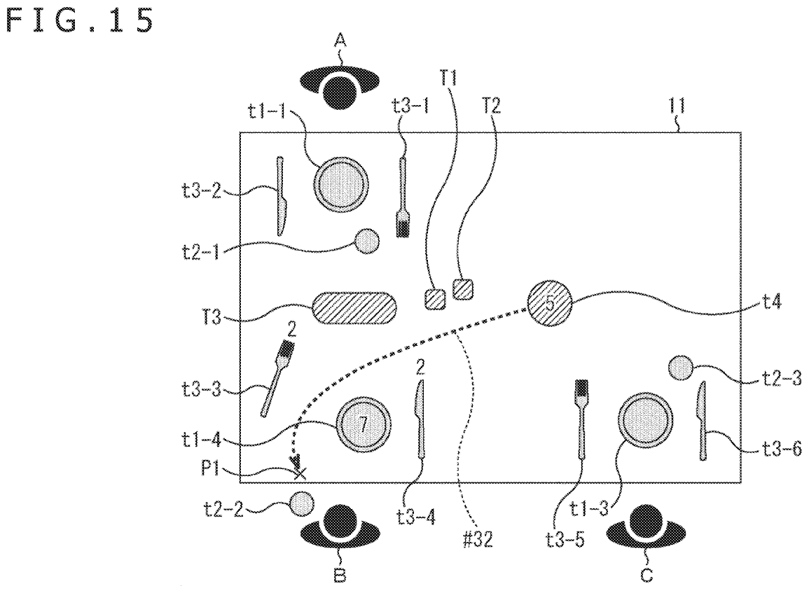

In this case, the priority level of the wine bottle T4 that is the target of the movement is lower than the priority level of the plate t1-4. Therefore, the movement path of the wine bottle T4 is reset to avoid the position of the plate t1-4 as indicated by a broken line #32 in FIG. 15.

Further, since the priority level of the cutlery t3-3 present on the reset movement path is lower than the priority level of the wine bottle T4, the cutlery t3-3 moves to avoid the reset movement path.

The wine bottle T4 can then move to the position P1 by using the path reset in such a manner and indicated by the broken line #32.

In such a manner, the movement of a piece of tableware is performed according to the priority levels set to the respective pieces of tableware. Setting of a priority level is hereinafter described.

### <Configuration and Operation of Host PC>

Configuration of Host PC

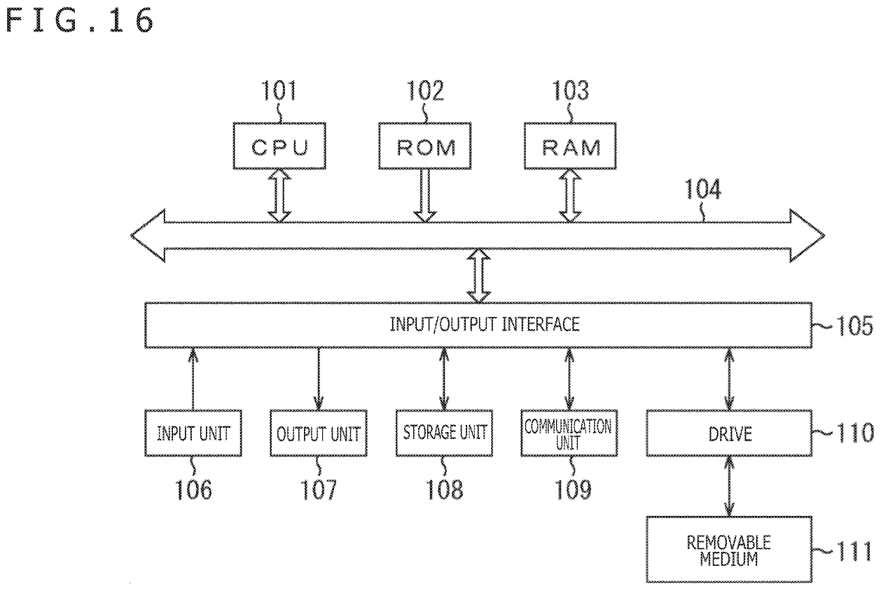

FIG. 16 is a block diagram depicting an example of a hardware configuration of the host PC 11.

A CPU (Central Processing Unit) 101, a ROM (Read Only Memory) 102, and a RAM (Random Access Memory) 103 are connected to one another by a bus 104.

An input/output interface 105 is further connected to the bus 104. To the input/output interface 105, an input unit 106 used for various operations and an output unit 107 including a speaker and so forth are connected.

Further, to the input/output interface 105, a storage unit 108 including a hard disk, a nonvolatile memory, or the like, a communication unit 109 including a short-range communication module, a network interface, and so forth, and a drive 110 for driving a removable medium 111 are connected. Communication between them and the mobile robots 1 is performed by the communication unit 109.

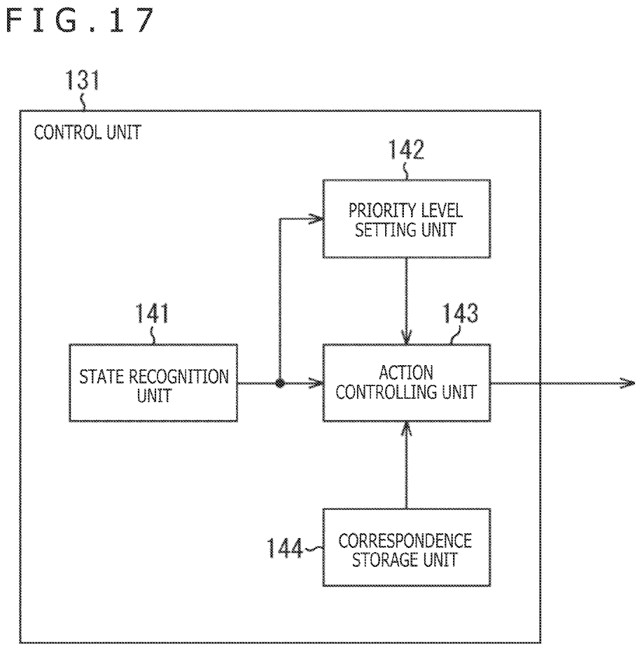

FIG. 17 is a block diagram depicting an example of a functional configuration of the host PC 11. At least some of functioning units depicted in FIG. 17 are implemented by execution of a predetermined program by the CPU 101 of FIG. 16.

A control unit 131 is implemented by the host PC 11. The control unit 131 includes a state recognition unit 141, a priority level setting unit 142, an action controlling unit 143, and a correspondence storage unit 144.

The state recognition unit 141 acquires information transmitted from the mobile robots 1 and received by the communication unit 109. For example, information indicative of the position and the posture of each of the mobile robots 1 is acquired by the state recognition unit 141.

The state recognition unit 141 further acquires various kinds of information to be used for recognition of a state, such as an image captured by the camera mounted above the table 21 and a result of detection by the sensors provided on the table 21.

The state recognition unit 141 recognizes the state of each of the mobile robots 1 that includes the position and the posture, on the basis of information transmitted thereto from each of the mobile robots 1 and an image captured by the camera.

Further, the state recognition unit 141 recognizes the state of users who have a meal, on the basis of an image captured by the camera. For example, the states in which a user is seated, is standing at a position close to the table 21, and ends the meal are recognized by the state recognition unit 141. Also, the state of the meal including the progress of the meal and the amount of foods and other states are recognized by the state recognition unit 141.

Information indicating the state of the mobile robots 1, the state of the users, and the state of the meal, which are recognized by the state recognition unit 141, is supplied to the priority level setting unit 142 and the action controlling unit 143.

The priority level setting unit 142 sets, for each piece of tableware, a priority level that is used for setting of a movement path. For example, the priority level of a piece of tableware is obtained from the sum of a fixed value and a variation value that are set for each piece of tableware.

The fixed value is a value decided on the basis of an attribute that does not change over time or according to a situation. Examples of such an attribute of tableware that does not change over time or according to a situation include the size and the shape.

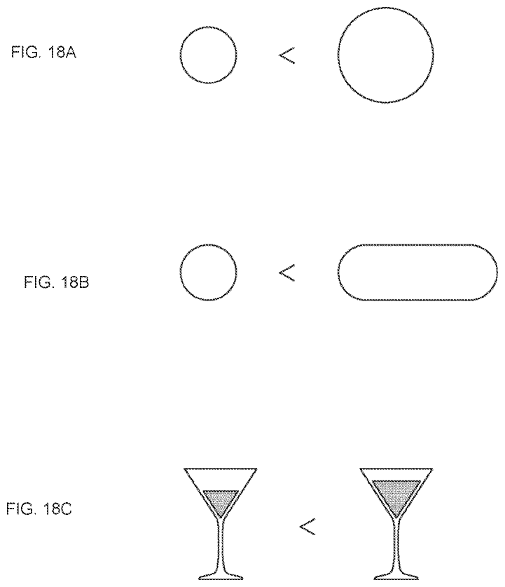

For example, a large plate or a plate of a complex shape is difficult to move in comparison with a small plate or a plate of a simple shape. Therefore, a high value is set to the fixed value of a large plate or a plate of a complex shape as depicted in A or B of FIG. 18. Accordingly, a high priority level is allocated to a large plate or a plate of a complex shape.

Further, even if the size is the same, the shared tableware has a higher fixed value than that of the individual tableware. Therefore, it is possible to allow a piece of shared tableware to promptly reach its goal position more easily.

A fixed value may be set not according to each of the attributes including the size and the shape of the tableware and whether the tableware is the shared tableware or the individual tableware, but according to a combination of two or more attributes. In other words, it is possible to set a fixed value on the basis of at least any of the attributes including the size and the shape of the tableware and whether the tableware is the shared tableware or the individual tableware.

The variation value is a value that changes over time or according to a situation.

For example, in a case where the contents in/on a piece of tableware such as the amount of drink in a glass or the amount of foods on a plate are plentiful, it is supposed not only that it is heavy but also that the user is still eating. Therefore, a high value is set to the variation value of a glass or a plate in which plentiful contents remain, as depicted in C of FIG. 18. The variation value is set according to the amount of the contents, and decreases as the amount of the contents decreases.

Further, depending upon the progress of a meal, some pieces of tableware are used but in low possibility. For example, in a case where a user is eating a main dish, there is a small possibility that a piece of tableware such as a coffee cup or a sugar container will be used. Therefore, according to the status of use of tableware that is determined depending upon the progress of a meal, a high value is set to the variation value of a piece of tableware that is highly associated with the food which the user is eating, while a low value is set to the variation value of a piece of tableware that is less associated with the food which the user is eating.

The variation value may otherwise be set on the basis of at least either the amount of the contents in/on a piece of tableware or the status of use of tableware determined depending upon the progress of a meal.

The priority level setting unit 142 uses the sum of such a fixed value and a variation value as described above to set a priority level for each piece of tableware and outputs information regarding the priority levels to the action controlling unit 143. Calculation other than the summing of a fixed value and a variation value may be performed on the basis of the fixed value and the variation value to set a priority level.

The action controlling unit 143 controls the communication unit 109 to transmit a command, to thereby control the action of each of the mobile robots 1.

For example, the action controlling unit 143 decides which one of the mobile robots 1 is to be moved, on the basis of information regarding the correspondence stored in the correspondence storage unit 144.

Further, the action controlling unit 143 sets a movement path for each of the mobile robots 1 on the basis of the position and the posture represented by information supplied from the state recognition unit 141 and of the priority levels set by the priority level setting unit 142. The action controlling unit 143 transmits a command according to the movement path to move the mobile robot 1 that is a target of the movement.

The correspondence storage unit 144 stores information that indicates the correspondence between the pieces of tableware, which is described hereinabove with reference to FIG. 9.

Operation of Host PC

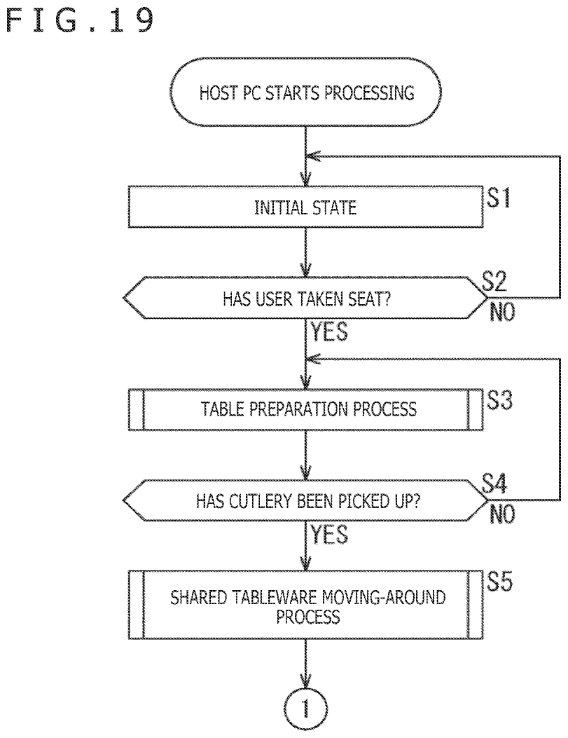

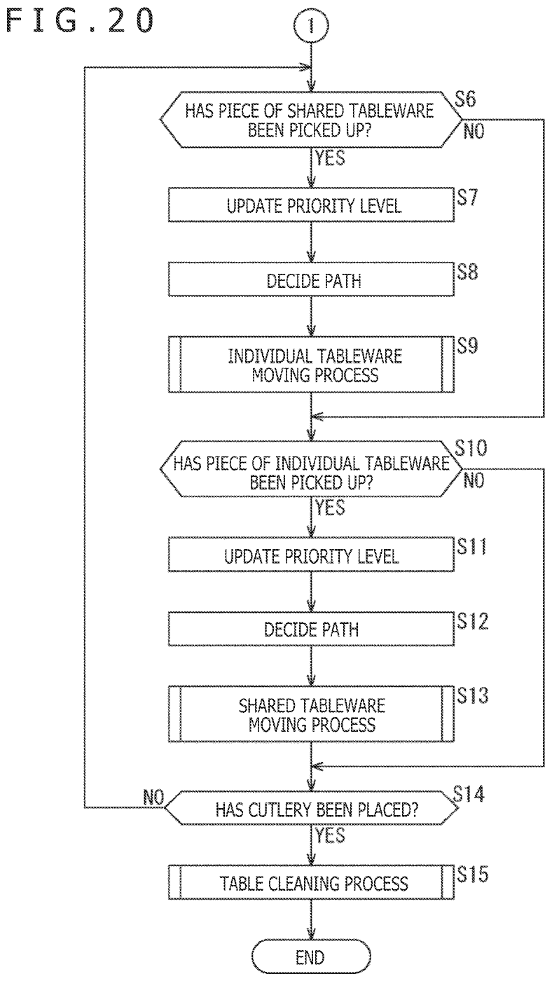

Here, general processing performed by the host PC 11 is described with reference to flow charts of FIGS. 19 and 20.

In step S1, the action controlling unit 143 sets the state of each piece of tableware to the initial state, which has described hereinabove with reference to FIG. 5, and then causes the pieces of tableware to stand by in the initial state.

In step S2, the action controlling unit 143 determines whether or not a user has taken a seat. In a case where it is determined in step S2 that the user has not taken a seat, the processing returns to step S1, and the pieces of tableware are kept on stand-by in the initial state.

In a case where it is determined in step S2 that the user has taken a seat, the action controlling unit 143 performs a table preparation process in step S3. The table preparation process is a process for placing pieces of individual tableware in front of the user who is seated, as described hereinabove with reference to FIG. 6.

In step S4, the state recognition unit 141 determines whether or not the user has picked up a cutlery.

In a case where it is determined in step S4 that the user has not picked up a cutlery, the processing returns to step S31, and the processes described above are repeated.

On the other hand, in a case where it is determined in step S4 that the user has picked up a cutlery, the action controlling unit 143 performs a shared tableware moving-around process in step S5. The shared tableware moving-around process is a process for causing the pieces of shared tableware to move around on the table by using an event that the cutlery is picked up as a trigger, as described hereinabove with reference to FIG. 7.

In step S6 of FIG. 20, the state recognition unit 141 determines whether or not the user has picked up a piece of the shared tableware which is moving around on the table.

In a case where it is determined in step S6 that the user has picked up the piece of the shared tableware, the priority level setting unit 142 updates, in step S7, the priority levels of the pieces of tableware that are used for setting of a movement path.

As described hereinabove, the variation value that is used for setting of a priority level is a value that changes over time or according to a situation. The priority levels of the respective pieces of tableware are set every time a certain piece of tableware is moved, and the priority levels that have been used are updated with the newly set priority levels.

In step S8, the action controlling unit 143 selects, as a movement target, a piece of individual tableware that corresponds with the piece of shared tableware picked up by the user, and decides a movement path of the piece of individual tableware that is selected as the movement target.

In step S9, the action controlling unit 143 performs an individual tableware moving process. The individual tableware moving process is a process for moving, in response to an event that the user picks up a piece of shared tableware, a piece of individual tableware corresponding with the piece of shared tableware toward the user, as described hereinabove with reference to FIG. 10.

In a case where it is determined in step S6 that the user has not picked up any piece of shared tableware, the processes in steps S7 to S9 are omitted.

In step S10, the state recognition unit 141 determines whether or not the user has picked up a piece of individual tableware.

In a case where it is determined in step S10 that the user has picked up a piece of individual tableware, the priority level setting unit 142 updates the priority levels of the pieces of tableware in step S11.

In step S12, the action controlling unit 143 selects, as a movement target, a piece of shared tableware that corresponds with the piece of individual tableware picked up by the user, and decides a movement path of the piece of shared tableware that is selected as the movement target.

In step S13, the action controlling unit 143 performs a shared tableware moving process. The shared tableware moving process is a process for moving, in response to an event that the user picks up a piece of individual tableware, a piece of shared tableware corresponding with the piece of individual tableware toward the user, as described hereinabove with reference to FIG. 8.

In a case where it is determined in step S10 that the user has not picked up any piece of individual tableware, the processes in steps S11 to S13 are omitted.

In step S14, the state recognition unit 141 determines whether or not the cutleries have been placed on the plate in a state of being diagonally arranged side by side.

In a case where it is determined in step S14 that the cutleries have not been placed, the processing returns to step S6, and the processes described above are repeated.

On the other hand, in a case where it is determined in step S14 that the cutleries have been placed, the action controlling unit 143 performs a table cleaning process in step S15. The table cleaning process is a process for moving, to the wagon 22, the pieces of individual tableware used by the user who finishes eating, as described hereinabove with reference to FIG. 11.

Through the processes described above, the host PC 11 can give such a presentation that pieces of tableware autonomously move in cooperation with each other according to a situation of a user who has a meal.

Further, the host PC 11 can set an appropriate priority level to each piece of tableware according to a situation of the meal or the like and can provide high-quality support to the users.

### <Others>

Although the foregoing description is given regarding a case where an object to be controlled by the host PC 11 is tableware, the host PC 11 may control the movement of any other object that are capable of moving autonomously, such as stationery, a cooking tool, or a machine tool.

In the above description, the host PC 11 controls tableware and updates a priority level, for example. However, at least some of the processes which are performed by the host PC 11 in the above description may be performed by the mobile robot 1. In this case, the mobile robot 1 includes at least some of the components of the control unit 131 described hereinabove with reference to FIG. 17. The mobile robot 1 can function as a control device that controls the movement of tableware.

Program

The series of processes described above can be executed by hardware or otherwise be executed by software. In a case where the series of processes is executed by software, a program included in the software is installed from a program recording medium into a computer incorporated in hardware for exclusive use, a personal computer for universal use, or the like.

The program to be installed is recorded on the removable medium 111, which is depicted in FIG. 16, including an optical disk (CD-ROM (Compact Disc-Read Only Memory), DVD (Digital Versatile Disc), or the like), a semiconductor memory, or the like, and is provided via the removable medium 111. Alternatively, the program may be provided via a wired or wireless transmission medium such as a local area network, the Internet, or a digital broadcast. The program can be installed in advance in the ROM 102 or the storage unit 108.

The program to be executed by the computer may be a program in which processing is performed in a time series according to the order described in the present specification, or may be a program in which processing is performed in parallel or at a necessary timing such as a timing when the program is called.

It is to be noted that, in the present specification, the term “system” is used to signify an aggregation of multiple components (devices, modules (parts), and so forth), and it does not matter whether or not all components are accommodated in the same housing. Accordingly, multiple devices accommodated in separate housings and connected to one another through a network and one device in which multiple modules are accommodated in a single housing are both systems.

Advantageous effects described in the present specification are merely exemplary and are not restrictive, and other advantageous effects may be produced.

The embodiment of the present technology is not limited to the embodiment described hereinabove, and various alterations can be made without departing from the subject matter of the present technology.

For example, the present technology can take a configuration of cloud computing in which one function is shared by multiple devices through a network and is processed cooperatively.

Further, the steps described hereinabove in connection with the flow charts can be executed by a single device or can be shared and executed by multiple devices.

Moreover, in a case where multiple processes are included in one step, the multiple processes included in the one step can not only be executed by a single device but also be shared and executed by multiple devices.

Example of Combination of Configurations

The present technology can also take such configurations as described below.

(1)

A control device including:

a control unit that moves, in response to an action made by a user on a predetermined object among multiple objects that are capable of moving autonomously, an object corresponding with the predetermined object.

(2)

The control device according to (1) above, in which

the multiple objects include a shared object that is shared by multiple users and an individual object that is used by each of the users.

(3)

The control device according to (2) above, in which

the control unit causes multiple individual objects allocated to the user, to be placed side by side on the basis of a position of the user.

(4)

The control device according to (2) or (3) above, in which

the control unit changes a placement position of the individual object according to an attribute of the user.

(5)

The control device according to any one of (2) to (4) above, in which

the control unit moves, in response to the action made on the shared object, the individual object corresponding with the shared object on which the action is made.

(6)

The control device according to any one of (2) to (4) above, in which

the control unit moves, in response to the action made on the individual object, the shared object corresponding with the individual object on which the action is made.

(7)

The control device according to any one of (1) to (6) above, in which,

in a case where, on a movement path of the object to be moved, another object is present, the control unit controls a movement of the object according to a priority level set to the object to be moved and a priority level set to the other object.

(8)

The control device according to (7) above, further including:

a priority level setting unit that sets the priority level of each of the objects on the basis of a first value based on a fixed attribute of the object and a second value based on a situation of the object that varies.

(9)

The control device according to (8) above, in which

the priority level setting unit sets the first value according to at least any of attributes including a size and a shape of the object and whether the object is the shared object or the individual object.

(10)

The control device according to (8) above, in which

the priority level setting unit sets the second value according to at least either an amount of contents in the object or a status of use of the object.

(11)

The control device according to any one of (1) to (10) above, in which

the object includes a piece of tableware, and

the control unit moves another piece of tableware that is used in combination with a piece of tableware picked up by the user.

(12)

The control device according to any one of (1) to (11) above, in which

the control unit moves an object corresponding with the predetermined object toward the user.

(13)

A control method including:

by a control device,

moving, in response to an action made by a user on a predetermined object among multiple objects that are capable of moving autonomously, an object corresponding with the predetermined object.

(14)

A program for causing a computer to execute a process of:

moving, in response to an action made by a user on a predetermined object among multiple objects that are capable of moving autonomously, an object corresponding with the predetermined object.

### REFERENCE SIGNS LIST

1-1 to 1-3: Mobile robot
11: Host PC
131: Control unit
141: State recognition unit
142: Priority level setting unit
143: Action controlling unit
144: Correspondence storage unit

1. A control device comprising:
a control unit that moves, in response to an action made by a user on a predetermined object among multiple objects that are capable of moving autonomously, an object corresponding with the predetermined object.

2. The control device according to claim 1, wherein
the multiple objects include a shared object that is shared by multiple users and an individual object that is used by each of the users.

3. The control device according to claim 2, wherein
the control unit causes multiple individual objects allocated to the user, to be placed side by side on a basis of a position of the user.

4. The control device according to claim 3, wherein
the control unit changes a placement position of the individual object according to an attribute of the user.

5. The control device according to claim 2, wherein
the control unit moves, in response to the action made on the shared object, the individual object corresponding with the shared object on which the action is made.

6. The control device according to claim 2, wherein
the control unit moves, in response to the action made on the individual object, the shared object corresponding with the individual object on which the action is made.

7. The control device according to claim 2, wherein,
in a case where, on a movement path of the object to be moved, another object is present, the control unit controls a movement of the object according to a priority level set to the object to be moved and a priority level set to the other object.

8. The control device according to claim 7, further comprising:
a priority level setting unit that sets the priority level of each of the objects on a basis of a first value based on a fixed attribute of the object and a second value based on a situation of the object that varies.

9. The control device according to claim 8, wherein
the priority level setting unit sets the first value according to at least any of attributes including a size and a shape of the object and whether the object is the shared object or the individual object.

10. The control device according to claim 8, wherein
the priority level setting unit sets the second value according to at least either an amount of contents in the object or a status of use of the object.

11. The control device according to claim 1, wherein
the object includes a piece of tableware, and
the control unit moves another piece of tableware that is used in combination with a piece of tableware picked up by the user.

12. The control device according to claim 1, wherein
the control unit moves an object corresponding with the predetermined object toward the user.

13. A control method comprising:
by a control device,
moving, in response to an action made by a user on a predetermined object among multiple objects that are capable of moving autonomously, an object corresponding with the predetermined object.

14. A program for causing a computer to execute a process of:
moving, in response to an action made by a user on a predetermined object among multiple objects that are capable of moving autonomously, an object corresponding with the predetermined object.
